(19) United States
(12) Patent Application Publication
(10) Pub. No.: US 2017/0011461 A1
(43) Pub. Date: Jan. 12, 2017

(54) METHOD AND DEVICE FOR BROKERING A COMPANY PENSION SCHEME

(71) Applicant: AUTOBAV GmbH & Co. KG, Moisburg (DE)

(72) Inventors: Jens Gause, Hollenstedt (DE); Torsten Burkart, Rheinstetten (DE)

(21) Appl. No.: 15/066,696

(22) Filed: Mar. 10, 2016

(30) Foreign Application Priority Data
Mar. 10, 2015 (EP) 15 158 503.1

(51) Int. Cl. G06Q 40/06; G06Q 40/08; G06Q 10/10

(52) U.S. Cl. CPC G06Q 40/06; G06Q 10/1057; G06Q 40/08

(57) ABSTRACT

A method for brokering a company pension scheme for employees of a company, wherein the method comprises the following steps:
(a) Establishing a data structure with basic project data concerning the company, on a central computer system;
(b) Creating a software program with the central computer system, which program has an input module and an encryption module, and comprises the basic project data;
(c) Transferring the software program from the central computer system to a computer system of the company, and running the software program on the computer system of the company;
(d) Via the input module, collecting personal data about an employee, including salary data;
(e) Encrypting confidential data about the employee via the encryption module, and generating a data set about the employee, comprised of an unencrypted part and an encrypted part, as well as a key for decrypting the encrypted part;
(f) Transferring the key to the employee;
(g) Transferring the data set to the central computer system;
(h) Transferring the key to the central computer system via the employee;
(i) Decrypting the encrypted part of the data set in the central computer system;
(j) Transmitting an offer to participate in the company pension scheme to the employee;
(k) Inputting the employee's decision about the offer into the central computer system; and
(l) Documenting the decision in the central computer system.

The invention relates to a method and a device for brokering a company pension scheme for employees of a company. A company pension scheme provides additional benefits to employees for old-age security, to supplement statutory pension insurance, and is also referred to as a “company pension”. The employee can designate part of his salary as a premium for the company pension scheme, in return for which he accumulates a claim for pension benefit payments. In the course of this, he can take advantage of tax benefits. The company that employs the employee must agree to this process, and generally will pay a portion of the employee's salary to support the insurance which will be the basis for the benefits later paid to the employee.

Although such a company pension is desirable from a policy standpoint, and is a good choice for most employees because of the above mentioned tax benefits, historically only a relatively small proportion of employees have participated in company pension schemes.

One reason for this is that a company pension scheme is a complex insurance product, and many insurance brokers lack the necessary knowledge for it. Another reason is that it is time-consuming and costly to act as a broker for company pension schemes, in particular since both the employee and his employer have to be involved in the consultation and decision process. This is appreciably different than the situation with most other insurance products, where the insured can obtain a policy directly from and with the insurer. Finally, the involvement of employees and the company is not only accompanied by high organizational effort and expense, but requires special security measures to meet the very stringent data protection requirements. Particularly critical from the data protection standpoint is the necessary exchange of salary information between the participants.

Brokering of a company pension scheme is thus largely a “manually performed” activity. Technical support means are used only for general management functions, or to support the participants in particular steps, e.g. for calculating the principal data in an offer. As a rule, the following steps are involved, in the order listed: Initially, the insurance broker contacts the company concerning the prospect of arranging for a company pension scheme for the employees. Generally, a personal conversation will follow, in which the broker provides information to the company about possible company pension schemes. In the next step, generally with a further personal conversation, the insurance broker will provide information to an employee of the company, concerning in particular the basic possibilities connected with a company pension. If the employee is interested in a concrete offer, he/she must give his/her consent for the company to provide the insurance broker with the necessary salary data. Only if this consent has been obtained can the company provide the insurance broker with the necessary data, enabling the broker to calculate a concrete offer for the employee. Generally, the offer will then be presented to the employee, with additional personal discussions. If the employee accepts the offer, typically after an appropriate review period of e.g. two weeks, he/she will so advise the insurance broker, usually via a (e.g.) third personal conversation. Then the insurance broker will need to obtain the approval of the company, followed by entering into a corresponding contract with an insurance company.

Based on the preceding, it is the object of the invention to devise a method for simplifying the brokering of a company pension scheme for employees of a company, enabling an insurance broker to broker a company pension scheme covering a number of employees of a company, with relatively little consumption of the broker's time, wherein all data protection requirements are adhered to and the brokers information and documentation obligations are met, as well as to devise a device for carrying out the method.

This object is solved by a method of brokering a company pension scheme for employees of a company, comprising the steps according to claim 1. Advantageous embodiments are set forth in the subsequent dependent claims.

The method comprises the following steps:
(a) Establishing a data structure with basic project data concerning the company, on a central computer system;
(b) Creating a software program with the central computer system, which program has an input module and an encryption module, and comprises the basic project data;
(c) Transferring the software program from the central computer system to a computer system of the company, and running the software program on the computer system of the company;
(d) Via the input module, collecting personal data about an employee, including salary data;
(e) Encrypting confidential data about the employee via the encryption module, and generating a data set about the employee, comprised of an unencrypted part and an encrypted part, as well as a key for decrypting the encrypted part;
(f) Transferring the key to the employee;
(g) Transferring the data set to the central computer system;
(h) Transferring the key to the central computer system via the employee;
(i) Decrypting the encrypted part of the data set in the central computer system;
(j) Transmitting an offer for the company pension scheme to the employee;
(k) Inputting the employee's decision about the offer into the central computer system; and
(l) Documenting the decision in the central computer system.

The central computer system is under the auspices and control of the insurance broker. It may comprise a single computer or server, or a plurality of interconnected networked computers. A program is run on the central computer system which enables the insurance broker in step (a) to collect the basic project data about the company and to create a corresponding data structure. This program may be, e.g., a CRM system (customer relations management).

The basic project data comprise underlying data required to carry out the brokering project for the company. These data include a project name, the company name of the company, and/or information about the divisions and/or locations of the company.

In step (b) a software program is created with the central computer system, which program comprises the input module, the encryption module, and the basic project data. In particular, this software program may be produced from the program running on the central system, into which the basic project data have been input. The software program may have an executable file which can be executed on a customary computer system without installing special software. All of the mentioned elements of the software program can be integrated into this executable file. Alternatively, other files may be included with which the executable file interacts.

In step (c), the software program is transferred from the central computer system to a computer system of the company, and is run on the computer system of the company. The computer system of the company may comprise a single computer or a computer network with a plurality of computers.

Then in step (d), with the aid of the software program running on the computer system of the company, personal data about an employee, including salary data, can be collected, namely with the input module of the software program. It is understood that, preferably, in this step the respective data of a number of employees of the company can be collected, in particular all employees to whom an offer of coverage under the company pension scheme is to be made. The personal data about an employee may comprise, e.g., the name, address, and birthdate of the employee, and possibly other information such as the position the employee holds in the company, a supervisor of the employee, and/or tax data such as, e.g. a tax classification. In addition, salary data about the employee will be collected, in particular the current gross salary. As already mentioned, these data are subject to stringent data protection requirements, and may not permissibly be disclosed to third parties, in particular the insurance broker, without the prior consent of the employee.

Then, in step (e), confidential data about the employee, in particular the previously collected salary data and possibly some of the personal data which have been collected, are encrypted with the encryption module of the software program. A data set concerning the employee is generated which is comprised of an unencrypted part and an encrypted part. Also, a key is generated, with which the encrypted part is decryptable.

The unencrypted part of the data set contains only information which is not subject to data protection requirements, such as the name of the employee or a personnel number by which the employee can be uniquely identified.

Steps (d) and (e), which are required for data subject to confidentiality protection, are carried out solely in the sphere of the company, namely via the computer system of the company. The confidential part of the data, particularly the salary information, is not accessible by third parties, particularly the insurance broker.

In the next step, (f), the key enabling decryption of the encrypted part of the data is transmitted to the employee.

In an additional step, (g), the data set with the data about the employee is transmitted to the central computer system. Because the confidential data in the data set are encrypted, there is continued assurance that third parties cannot access the data. All that the insurance broker is able to determine with the aid of the unencrypted data in the data set is what employee is associated with the given data set which has been sent to the central computer system. All data needed for advising the employee are now resident in the central computer system.

Only in a further step, (h), in which the employee transmits the key to the central computer system, can the confidential data relating to the employee be evaluated, and used for advising the employee, in particular in connection with developing a personal offer. When the employee transmits the key, he/she simultaneously gives his permission for the insurance broker to use his/her data for this purpose.

In step (i), the encrypted part of the data set is then decrypted in the central computer system, enabling an offer for participation in the company pension scheme to be presented to the employee.

In step (k), after the employee evaluates the offer, the employee can enter his/her decision concerning the offer into the central computer system. In particular, he/she may accept or decline the offer.

Finally, in step (l), the employee's decision about the offer is documented in the central computer system. With this documentation, the insurance broker can see how the automated advising of the employee has proceeded.

It is understood that other persons than just the employee might participate in the described method steps, such as an insurance broker, who may carry out step (a), and a co-employee of the employee, who, in step (d), may collect the data about the employee. However, it is possible that these steps may be partially or completely automated. Any persons who participate may be provided with one type or another of access to the various computer systems. E.g., the employee may interact with a web server of the central computer system via a web browser, in particular over a secure link.

The invention overcomes the initially described difficulties by employing various technical means. It goes somewhat farther than mere automation of previously manually performed steps. In particular, in the form of the software program which runs on the computer system of the employer, one has a technical aid which is well suited for collecting, in a very simple manner, all of the relevant data about the employee of the company, with the aid of a particular data structure.

By shifting this data collection into the auspices and control of the company, the data may be collected without prior consent from the particular employee. By means of the encryption, which is also under the auspices and control of the company, the data which are later needed can also be transmitted into the auspices of the insurance broker, namely into the central computer system, also independently of the consent of the particular employee.

Here and in what follows it is understood that it is contemplated that the role of the insurance broker may be fulfilled by an insurance company. In such a case, the central computer system will be under the auspices and control of the insurance company.

The inventive method simplifies the brokering of a company pension scheme involving an appreciable number of employees in a quite evident manner, for the broker, who in particular is relieved of the burden of obtaining the consent of the employee to access his/her data. Also advantageous is the fact that the amount of interaction by the employee is minimized. In particular, it is possible for an employee to obtain basic information about the company pension scheme and to immediately receive an individual offer, in a single automated consultation process.

According to an embodiment of the invention, the preparation of an offer to participate in the company pension scheme comprises the following steps:
(m) Setting a net premium for the employee;
(n) Calculating a gross premium for the company pension scheme based on the salary data and the proposed net premium, taking into account taxes and social insurance contributions;
(o) Calculating an insurance benefit based on the gross premium and the personal data of the employee;

Thus, based on the net premium which the employee is prepared to pay, and taking into account the salary data and the contributions which the employee will make, the system determines what insurance benefits (pension payments) the employee will receive. It should be understood that in this manner it is possible to prepare a number of offers, e.g. a different offer for possibly considered net premiums of e.g. EUR 20, EUR 30, EUR 50, and EUR 75 per month. In each case, an appropriate offer for the employee will be prepared.

According to an embodiment, steps (n) and (o) will be carried out by the computer system of the company. For this purpose, the software program that is running on that computer system may have, in addition to the input module and the encryption module, a calculation module for carrying out those steps. In this case, the relevant data for the offer which will be presented to the employee will be integrated into the data set that will be transferred to the central computer system via the employee. During the automated consultation, the offer can then be directly presented, without requiring additional calculations. Alternatively, the aforesaid steps may be carried out in the central computer system. Under these circumstances it is in particular possible for the employee to submit his/her desired net premium, and based on this a concrete offer will be developed during the consultation session.

According to an embodiment, the employee receives information concerning the company pension scheme from the central computer system, and confirms that he/she has received the information, which confirmation is documented in step (l). In this way, the information obligations of the company and/or the broker are automatically fulfilled during the automated consultation, and this compliance is documented.

In an embodiment, the information about the company pension scheme is provided in the form of video sequences which are provided from the central computer system. In this connection, for example, the employee's supervisor may be included in a video in which the supervisor communicates directly to the employee, and even replies to the employee. This enables a particularly well suited and personal means of communication of information.

In an embodiment, the input module has an interface connecting to a salary accounting program of the company, and the collection of salary data in step (d) is carried out automatically via this interface. The salary accounting program may be, e.g., an SAP system which is used by the company and which contains all of the required data about the employee. The use of an automated interface substantially reduces the labor expenditure for the company, particularly when a number of employees is to be included.

In an embodiment, the key transmitted in step (f) is printed out by the computer system of the company, and the printout is attached to a payroll slip of the employee. In this way, it is ensured that the employee will receive the key, and that the data protection requirements will be satisfied, in accordance with the usual method of delivery of payroll slips.

In an embodiment, in step (k) the employee agrees to participate in the company pension scheme, following which at least one of the following steps are carried out:
(p) Generating a data set with accounting-relevant information about the participation agreed to, and transmission of this data set to the computer system of the company;
(q) Generating a data set with insurance-relevant information about the participation agreed to, and automatic transmission of this data set to a computer system of an insurance company;
(r) Generating a data set with broker-relevant information about the participation agreed to, and automatic transmission of this data set to a computer system of an insurance broker;
(s) Generating a data set with employee-relevant information about the participation agreed to, and automatic transmission of this data set to the employee.

Steps (p) through (s) can be carried out by the central computer system. Each of the steps achieves automation of part of the measurements necessary after having contracted for participation in the company pension scheme. All of the individuals and companies involved can be automatically supplied with the data which are relevant to them. It goes without saying that the data sets which are generated can further be transmitted in encrypted form.

In an embodiment, the data set with the employee-relevant information is encrypted using the key, and is automatically electronically transmitted to the employee. In this way, the requirements for data protection are met, without having to generate a new key and having to transmit the new key. The employee can immediately inspect the information which is most important to him/her, by using the same key which was previously used.

In an embodiment, the data set with the employee-relevant information is used to produce a document displaying this information, and this document is automatically sent to the employee.

In this way, the employee receives the information relevant to him/her in paper form, while at the same time the data protection requirements can be satisfied in the course of the sending of the document.

According to another refinement of the invention, in step (k) the employee declines participation in the company pension scheme, and then information about this decision of the employee is automatically transmitted to the computer system of the company. In this way, the company can at any time determine that the employee has gone through consultation about the company pension scheme, even though the employee did not decide to participate in it.

According to yet another refinement of the invention, the data set transmitted in step (g) contains information from the company concerning the company pension scheme, and in particular the fact that the company approves participation by the employee. This information can be input by the company in the course of collecting the personal data about the employee, in step (d). Alternatively, the set information may already be contained in the basic project data, and in particular may be input by the insurance broker, possibly after conferring with the company. This information may contain, e.g., a minimum and maximum amount of gross salary to be taken into account for the company pension scheme. The subsequently prepared offers can then automatically take into account these data. The particular advantage is provided in that the employee already has the approval of the company for his;/her participation in the company pension scheme, at the time that he/she receives an offer, so that the employee upon receipt of the offer can immediately and finally decide to participate in the company pension scheme. This affords an additional simplification of the process, with reduced processing expense to the broker and to the company as well, because it eliminates the subsequent approval of the decision of the employee.

The second aspect of the underlying problem of the invention is solved by a device for brokering a company pension scheme for employees of a company, comprising the features set forth in claim 13. Advantageous refinements are set forth in the subsequent dependent claims.

The device, which serves to carry out the brokering of a company pension scheme for employees of a company, is comprised of a central computer system and a computer system associated with the company, for carrying out the method according to claim 1, and has the following features:
(a) the central computer system is configured to generate a data structure with basic project data about the company;
(b) the central computer system is configured to generate a software program which comprises an input module and an encryption module, along with the basic project data;
(c) the device is configured to transfer the software program from the central computer system to a computer system of the company, and to run the software program on the computer system of the company;
(d) the input module is configured to collect personal data about an employee, including salary data;
(e) the encryption module is configured to encrypt confidential data about the employee and to generate a data set about the employee, containing an unencrypted part and an encrypted part, and further to generate a key with which the encrypted part is decryptable;
(f) the device is configured to send the key to the employee;
(g) the device is configured to send the data set to the central computer system;
(h) the device is configured to send the key to the central computer system via the employee;
(i) the central computer system is configured to decrypt the encrypted part of the data set;
(j) the device is configured to send an offer for participation in the company pension scheme to the employee;
(k) the central computer system is configured for inputting of a decision about the offer, via the employee; and
(l) the central computer system is configured to document the decision.

The configuration of the device, the central computer system, or the computer system for carrying out one or more of the above mentioned steps, may be brought about by suitable programming. For a discussion of the features of the device and their advantages, reference is made to the discussion of the corresponding method features hereinabove.

According to further embodiments, the device is configured to carry out a method according to one of claims 2 to 12. In particular, the device, the central computer system, and/or the computer system of the company is/are configured to carry out one or more of the steps.

The invention will now be described in more detail with reference to the exemplary embodiments illustrated in the drawings.

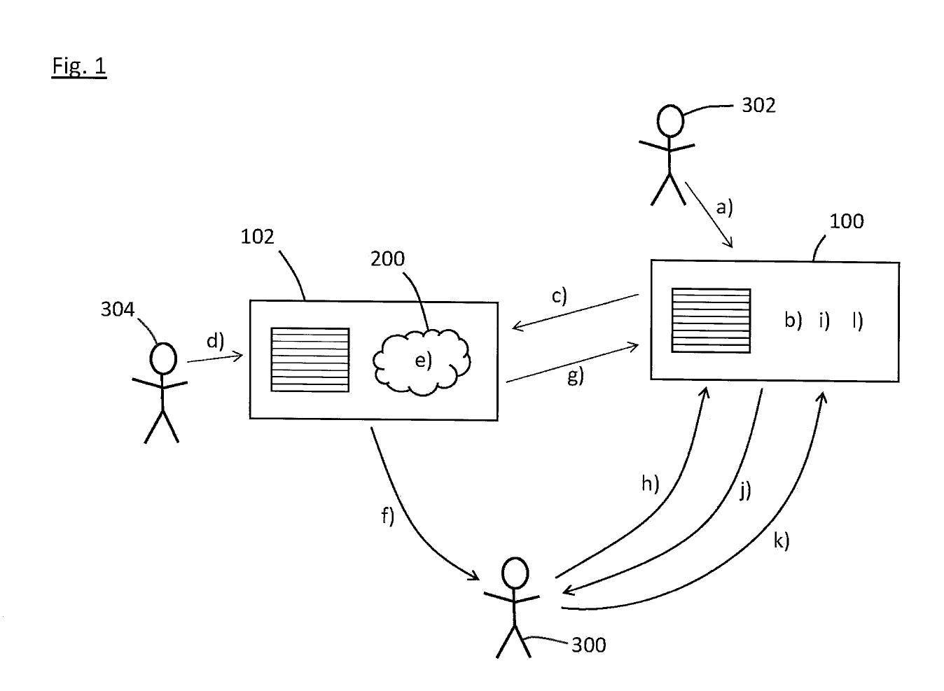

FIG. 1 is a schematic representation of the principal method steps, with the individuals and computer systems involved; and

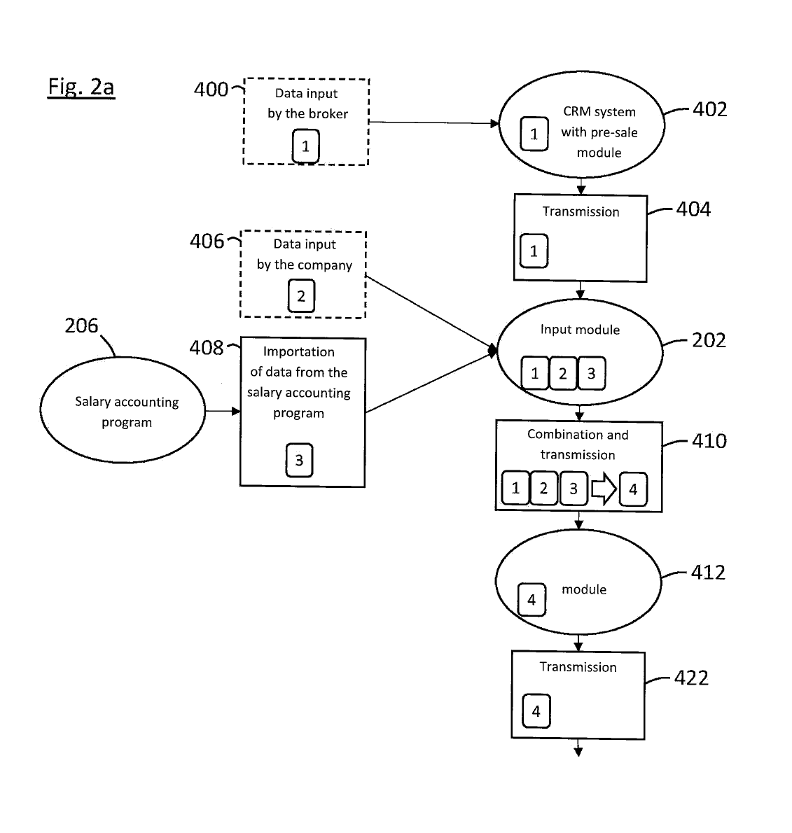

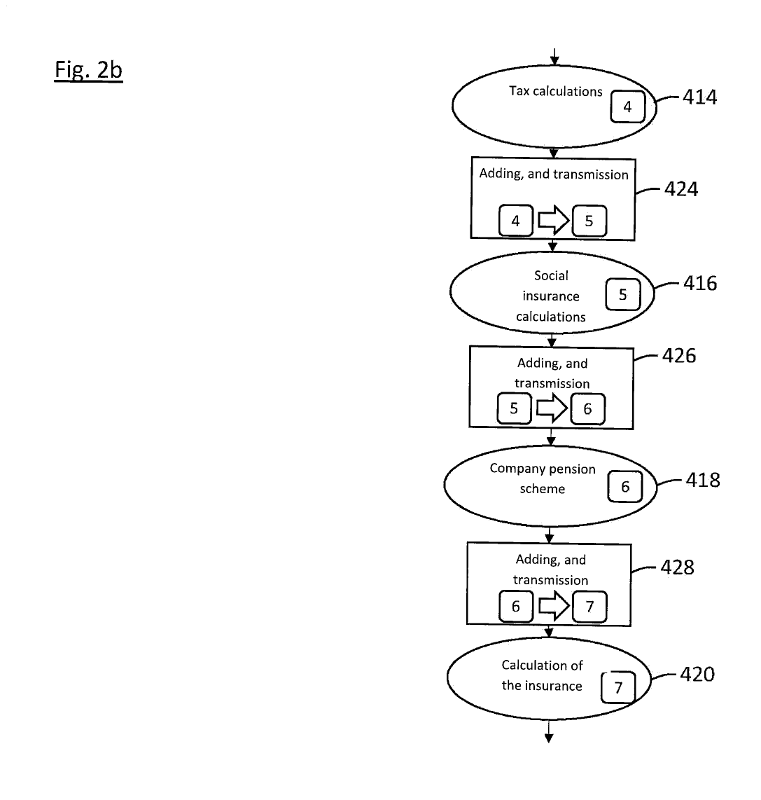

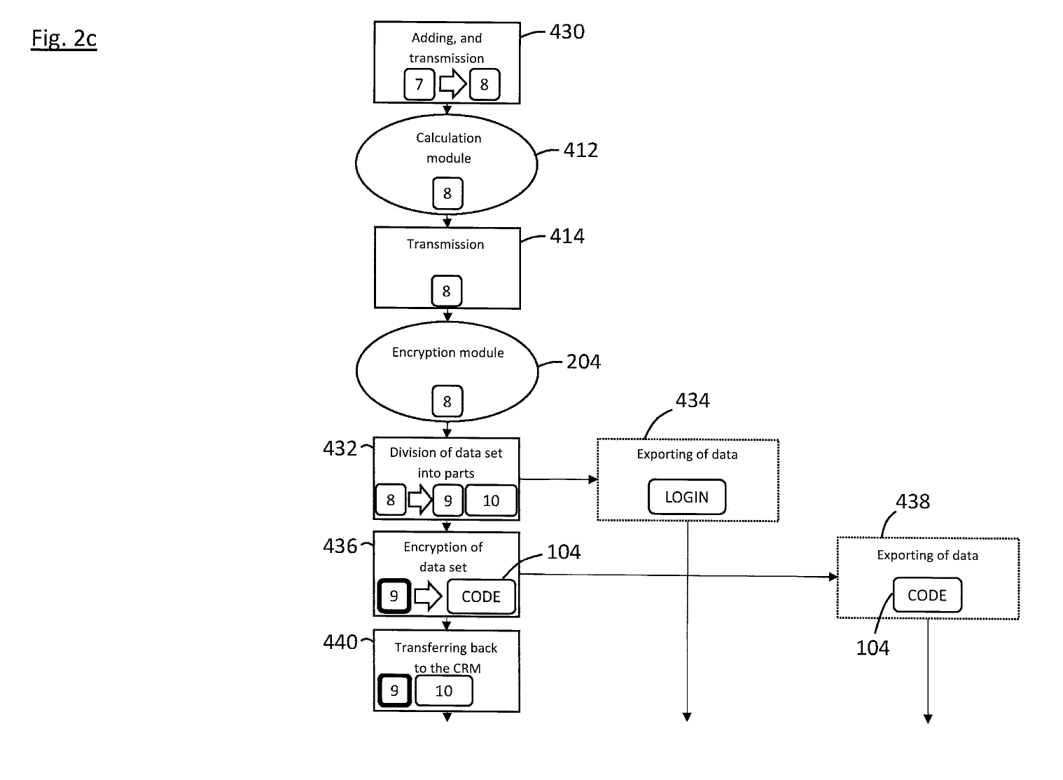

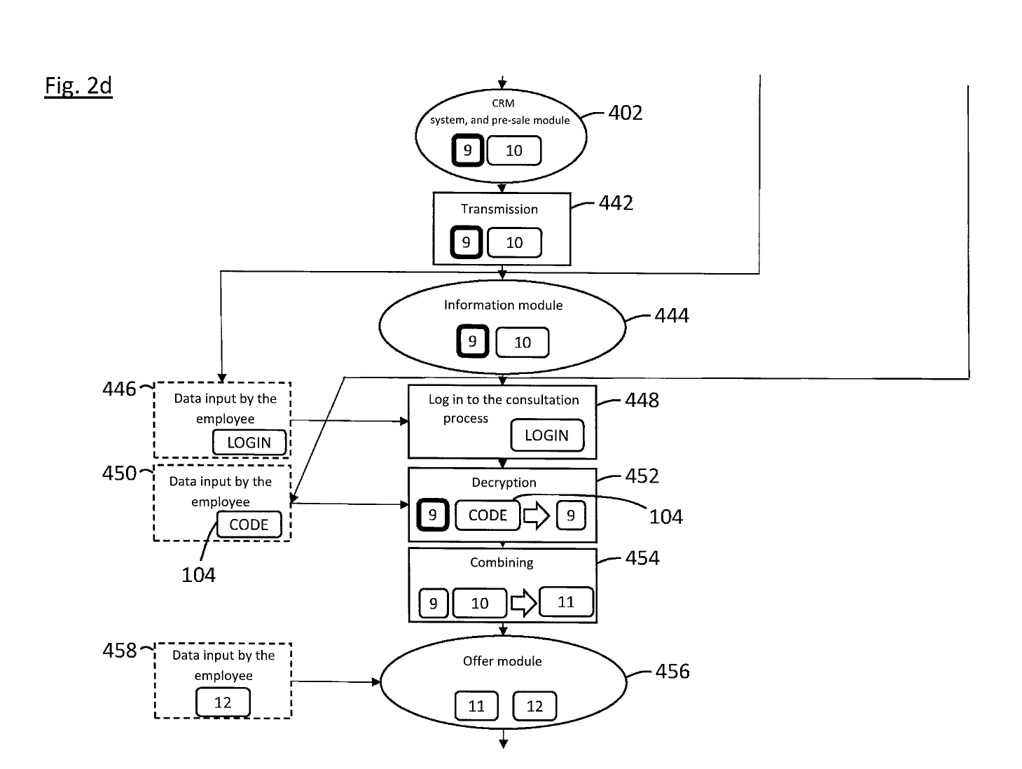

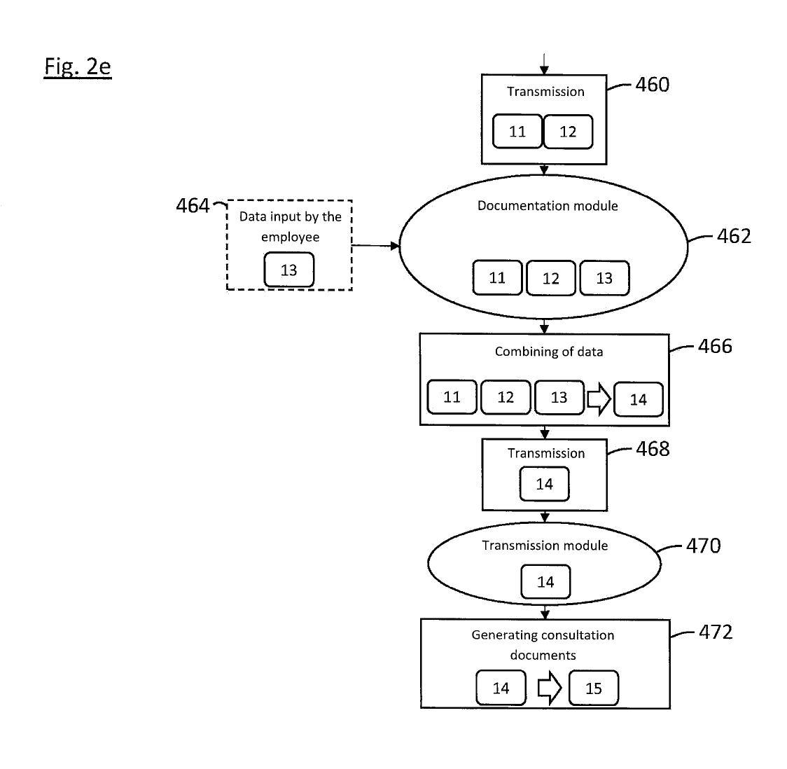

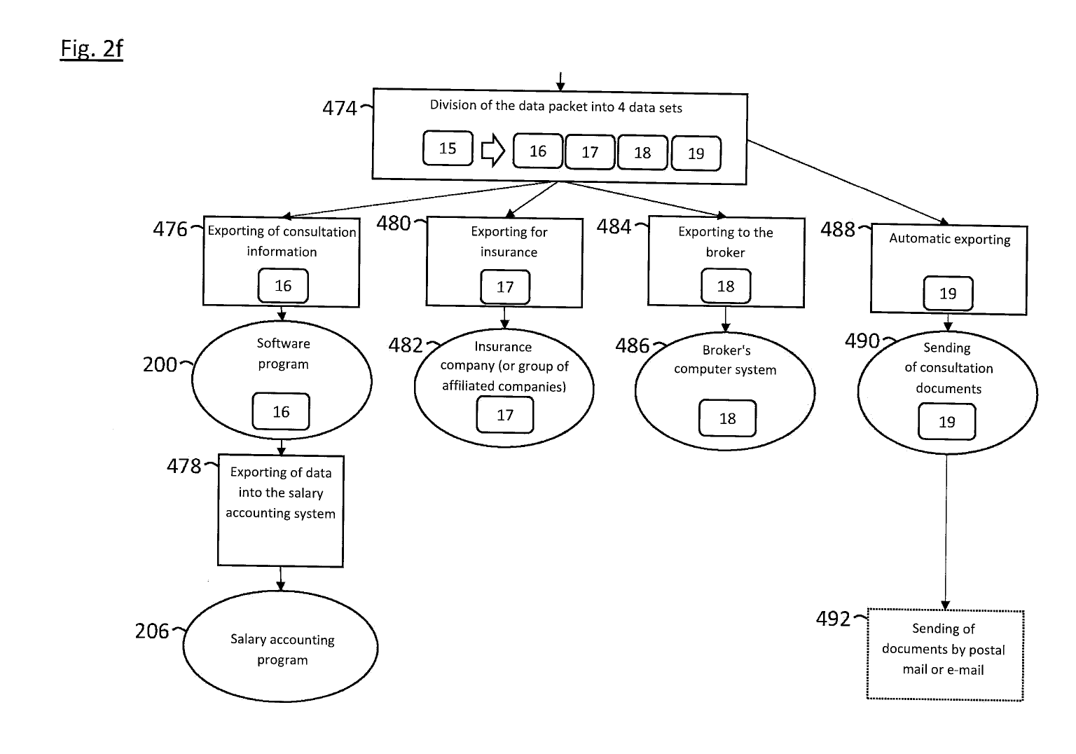

FIGS. 2a through 2f each present a detailed flow diagram of the course of the method, according to an exemplary embodiment.

FIG. 1 illustrates an insurance broker 302 who, in step (a), via a central computer system 100 under the auspices and control of the broker and accessible by the broker via, e.g., a web interface, creates a data structure with basic project data about a company which seeks to collaborate with the broker in brokering a company pension scheme for the company's employees. In this connection, the insurance broker 302, in accordance with software, e.g. a CRM system, running on the central computer system 100, enters a project name, the name of the company, and information about the divisions and locations of the company.

Then, in step (b), the central computer system 100 generates a software program 200 which comprises an input module and an encryption module, along with the basic project data.

In step (c), the software program is transferred from the central computer system 100 to a computer system 102 of the company, and is run on the computer system of the company.

Then, in step (d), an employee 304 of the company, e.g. in the bookkeeping department, collects personal data about an employee 300, including salary data. For this purpose, he/she employs an input module of the software 200.

In step (e), the encryption module of the software 200 encrypts confidential data about the employer 300 and generates a data set about the employee 300 which contains an unencrypted part and an encrypted part.

In step (f), a key 104 for decrypting the encrypted part of the data, which key is also generated by the encryption module, is transmitted to the employee 300. It is understood that all steps can be carried out for a plurality of employees 300 at the same time, in particular for all employees of the company who are candidates for brokered participation in the company pension scheme.

In step (g), the data set is sent to the central computer system 100.

When the employee 300 wants to obtain information about the company pension scheme, in step (h) he/she inputs his key into the central computer system 100, e.g. by transmitting the key via a web interface.

Then, in step (i), the central computer system 100 decrypts the encrypted part of the data set about the employee 300 which has been stored in the central computer system 100.

In step (j), the central computer system 100 transmits a personal offer to participate in the company pension scheme to the employee 300. This transmission of the offer can be carried out, e.g., by displaying of the offer in a web browser which the employee 300 uses to access the central computer system 100, e.g. via a secure link.

In step (k), after the employee evaluates the offer, the employee 300 can enter his/her decision concerning the offer into the central computer system 100.

Subsequently, in step (l), the employee's decision is documented in the central computer system 100.

Details of the method can be appreciated with the aid of the detailed representations in FIGS. 2a through 2f In the flow diagrams, small boxes with rounded corners represent virtual data packets. Rectangles with dashed-line borders represent data input steps. Rectangles with dotted-line borders represent data outputs. Oval elements represent software or hardware components. Rectangles with solid-line borders represent method steps.

The method starts with step 400 (FIG. 2a upper left) in which an insurance broker inputs basic project data 1. This occurs with the aid of a pre-sale module 402 of a CRM system, with a software component running on the central computer system 100. The pre-sale module 402 then generates the above-described software program 200 which in step 404 is transmitted to the computer system 102 of the company.

There the software program 200 is run, with initial preparation of the input module 202 of the software program 200. This input module 202 is used at 406 for data input by the company, namely input of personal data 2 about the employee 300, containing, e.g., the name and birthdate, and information concerning the employee's position in the company and concerning his/her supervisors.

The input module 202 is also used, in step 408, to collect salary data 3, in the example illustrated through importation of data from a salary accounting program 206, via an interface of the software program 200 which interface is intended for this purpose.

In step 410, the data 1, 2, and 3 are combined, to generate a comprehensive data set 4. This data set 4 is transferred to a calculation module 412 of the software program 200. The calculation module 412 comprises additional subunits 414, 416, 418, and 420, in which the additional information is added to the data set 4.

For this purpose, first, in step 422, the data set 4 is sent to subunit 414 for calculation of tax aspects. For each employee 300, the subunit 414 for calculation of tax aspects (see FIG. 2b) calculates individual tax components, starting with the gross salary contained in the data set 4, and these tax components are added to the data set 4 in step 424, giving rise to an enhanced data set 5. Then, in step 424, this data set is transmitted to subunit 405 for calculation of social insurance aspects, in particular calculation of individual social insurance contributions. In step 426 this information is added to the data set 5, resulting in a further enhanced data set 6; in step 426, this is transmitted to the subunit 418, “company pension scheme”.

In subunit 418, “company pension scheme”, for a given net premium, which may be input by the employee 300, a gross premium for the company pension scheme is calculated. In step 428, this is added to the data set 6, resulting in a further enhanced data set 7, which is transmitted to subunit 420 for calculating the insurance.

The subunit 420 for calculating the insurance calculates the future insurance benefits, based on the gross premium and additional personal data about the employee 300, in particular his/her birthdate. In step 430 (see FIG. 2c), this is added to the data set 7, giving rise to data set 8 concerning the employee 300. Then, in step 414, the data set 8 is transmitted from the calculation module 412 of the software program 200 to the encryption module 204 of the software program 200.

The data set 8 is divided by the encryption module 204 into a part 9 having confidential data and another part 10. This is carried out in step 432. Parallel to this, in step 434, login data for the employee 300 later to log into the central computer system 100 is exported.

In step 436, the encryption module 204 encrypts the confidential data about the employee, giving rise to an encrypted part 9 of the data set 8 as well as a key 104. Here and in what follows, the data packets with encrypted data are designated by a bold border line.

In step 438, carried out in parallel with the above, the encryption module 206 exports the key 104.

In step 440, the encrypted part 9 and the unencrypted part 10 of the data set about the employee 300 are returned to the pre-sale module 402 of the CRM system.

In step 442 (see FIG. 2d), the encrypted part 9 and the unencrypted part 10 of the data set are transmitted to the information module 444 of the CRM system, which also runs on the central computer system 100.

In step 446, the employee 300 inputs his/her login data into the central computer system 100, in particular via a web interface, so that in step 448 the employee can apply for the automated consultation process.

In step 450, the employee 300 also inputs the key 104, so that in step 452 the encrypted part 9 of the data set can be decrypted and converted to readable form.

In the following step 454, the again decrypted confidential information (a data packet, data packet 9) is combined with the unencrypted part 10 of the data set, to form a new data set 11 about the employee 300. The data set 11 is transmitted to the offer module 456 of the CRM system, which also runs on the central computer system 100. In step 458, the employee 300 inputs additional data, e.g. his/her selected net premium.

In step 460, the data set 11 and the newly input data 12 are transmitted to the documentation module 462 of the CRM system (see FIG. 2e), which also runs on the central computer system 100. In step 464, the employee 300 inputs additional data. In particular, at this point he/she may accept the offer (for example), with his/her information being represented by data packet 13.

In step 466, the data collected are combined into a new data packet 14, which then, in step 468, is transmitted to the transmission module 470 of the CRM system, which also runs on the central computer system 100. In step 472, the transmission module, based on the data set 14, generates various consultation documents 15. In step 474 (see FIG. 2f), accordingly, four different data sets are generated.

Data set 16 contains accounting-relevant information, and in step 476 this is automatically exported to the software program 200, and in the subsequent step 478, automatic data export into the salary accounting program 206 takes place.

The data set 17 contains insurance-relevant information about the company pension scheme participation agreed to, and in step 480 this is automatically exported to a computer system 482 of the insurance company or affiliated group of insurance companies.

In step 484, the data set 18 which contains broker-relevant information about the company pension scheme participation agreed to is automatically exported to a computer system 486 of the insurance broker.

In step 488, the data set 19 which contains employee-relevant information about the company pension scheme participation agreed to is automatically exported to the employee 300. For this purpose, the described data is exported to a document-sending apparatus 490 which in turn generates a corresponding document, and, in step 492, for example, sends the document by mail to the employee 300.

1. A method for brokering a company pension scheme for employees of a company, wherein the method comprises the following steps:
(a) Establishing a data structure with basic project data (1) concerning the company, on a central computer system (100);
(b) Creating a software program (200) with the central computer system (100), which program (200) has an input module (202) and an encryption module (204), and comprises the basic project data (1);
(c) Transferring the software program (200) from the central computer system (100) to a computer system (102) of the company, and running the software program (200) on the computer system (102) of the company;
(d) Via the input module (202), collecting personal data (2) about an employee (300), including salary data (3);
(e) Encrypting confidential data about the employee (300) via the encryption module (204), and generating a data set about the employee (300), comprised of an unencrypted part (10) and an encrypted part (9), as well as a key (104) for decrypting the encrypted part (9);
(f) Transferring the key (104) to the employee (300);
(g) Transferring the data set to the central computer system (100);
(h) Transferring the key (104) to the central computer system (100) via the employee (300);
(i) Decrypting the encrypted part (9) of the data set in the central computer system (100);
(j) Transmitting an offer to participate in the company pension scheme to the employee (300);
(k) Inputting the decision of the employee (300) about the offer into the central computer system (100);
(l) Documenting the decision in the central computer system (100).

2. The method according to claim 1; characterized in that the preparation of an offer for participation in the company pension scheme comprises the following steps:
(m) Setting a net premium for the employee (300);
(n) Calculating a gross premium for the company pension scheme based on the salary data (3) and the proposed net premium, taking into account taxes and social insurance contributions;
(o) Calculating an insurance benefit based on the gross premium and the personal data (2) of the employee (300);

3. The method according to claim 1; characterized in that the steps (n) and (o) are carried out by the computer system (102) of the company.

4. The method according to claim 1; characterized in that the employee (300) receives information about the company pension scheme from the central computer system (100), and confirms the receipt of this information, which confirmation is documented in step (l).

5. The method according to claim 4; characterized in that the information about the company pension scheme is provided in the form of video sequences which are provided from the central computer system (100).

6. The method according to claim 1; characterized in that the input module (202) has an interface to a salary accounting program (206) of the company, and the collection of salary data (3) in step (d) occurs automatically via this interface.

7. The method according to claim 1; characterized in that the key transferred in step (f) is printed out by the computer system (102) of the company; and in that the printout is attached to a payroll slip of the employee (300).

8. The method according to claim 1; characterized in that, in step (k), the employee (300) agrees to participate in a company pension scheme; and that subsequently at least one of the following steps is carried out:
(p) Generating a data set (16) with accounting-relevant information about the participation agreed to, and transmission of this data set to the computer system (102) of the company;
(q) Generating a data set (17) with insurance-relevant information about the participation agreed to, and automatic transmission of this data set to the computer system of an insurance company or group of affiliated insurance companies;
(r) Generating a data set (18) with broker-relevant information about the participation agreed to, and automatic transmission of this data set to a computer system of an insurance broker;
(s) Generating a data set (19) with employee-relevant information about the participation agreed to, and automatic transmission of this data set to the employee (300).

9. The method according to claim 8; characterized in that the data set (19) with the employee-relevant information is encrypted using the key (104), and is automatically electronically transmitted to the employee (300).

10. The method according to claim 8; characterized in that the data set (19) with the employee-relevant information is used to produce a document displaying this information, and this document is automatically sent to the employee (300).

11. The method according to claim 1; characterized in that, in step (k), the employee (300) declines to participate in a company pension scheme; and that subsequently information about this decision of the employee is automatically sent to the computer system (102) of the company.

12. The method according to claim 1; characterized in that the data set transmitted in step (g) contains information from the company concerning the company pension scheme, and in particular the fact that the company approves participation by the employee.

13. A device for brokering a company pension scheme for employees of a company, wherein the device is comprised of a central computer system (100) and a computer system (102) associated with the company, for carrying out the method according to claim 1, and has the following features:
(m) the central computer system (100) is configured to generate a data structure with basic project data (1) about the company;
(n) the central computer system (100) is configured to generate a software program (200) which comprises an input module (202) and an encryption module (204), along with the basic project data (1);
(o) the device is configured to transfer the software program (200) from the central computer system (100) to the computer system (102) of the company, and to run the software program (200) on the computer system (102) of the company;
(p) the input module (202) is configured to collect personal data (2) about an employee (300), including salary data (3);
(q) the encryption module (204) is configured to encrypt confidential data about the employee (300) and to generate a data set about the employee (300), containing an unencrypted part (10) and an encrypted part (9), and further to generate a key (104) for decrypting the encrypted part (9);
(r) the device is configured to send the key (104) to the employee (300);
(s) the device is configured to send the data set to the central computer system (100);
(t) the device is configured to send the key (104) to the central computer system (100) via the employee (300);
(u) the central computer system (100) is configured to decrypt the encrypted part (9) of the data set;
(v) the device is configured to send an offer for participation in the company pension scheme to the employee (300);
(w) the central computer system (100) is configured for inputting of a decision about the offer, via the employee (300); and
(x) the central computer system (100) is configured to document the decision.

14. The device according to claim 13; characterized in that the device is configured to carry out a method according claim 2.
